(19) United States
(12) Patent Application Publication
(10) Pub. No.: US 2015/0066201 A1
(43) Pub. Date: Mar. 5, 2015

(54) REAL-TIME 3-D IDENTIFICATION OF SEEMINGLY IDENTICAL OBJECTS

(71) Applicants: WILLIAM HOBSON WUBBENA, FT. COLLINS, CO (US); DI WANG, NASHVILLE, TN (US)

(72) Inventors: WILLIAM HOBSON WUBBENA, FT. COLLINS, CO (US); DI WANG, NASHVILLE, TN (US)

(21) Appl. No.: 14/320,162

(22) Filed: Jun. 30, 2014

Related U.S. Application Data
(60) Provisional application No. 61/840,568, filed on Jun. 28, 2013.

(51) Int. Cl. B65G 43/08

(52) U.S. Cl. CPC B65G 43/08
USPC 700/226

(57) ABSTRACT

A system for conducting real-time multi-dimension inspection of multiple objects, particularly for use with a conveyor belt carrying multiple boxes and packages, many of which are seemingly identical to each other. A plurality of real-time vision sensors and other sensors are positioned above the conveyor belt to observe and record data in real-time of packages and boxes as they move on the belt. The vision sensors include, but are not limited to, 3D sensors, cameras, structured light sensors, time of flight sensors, laser sensors, infrared sensors, and the like. Other sensors include, but are not limited to, multi-package bar code readers and other forms of specialized sensors.

This application claims benefit of and priority to U.S. Provisional Application No. 61/840,568, filed Jun. 28, 2013, by William Hobson Wubbena, and is entitled to that filing date for priority. The specification, figures, appendix and complete disclosure of U.S. Provisional Application No. 61/840,568 are incorporated herein by specific reference for all purposes.

### FIELD OF INVENTION

This invention relates to a method for robotic vision guidance and operations, and automated multi-dimensional inspection. More specifically, this invention relates to a method for automatically identifying seemingly identical physical objects such as boxes, packages, parts and other objects that require different outcomes and handling based on other inherent attributes.

### SUMMARY OF INVENTION

In various embodiments, the present invention comprises a system for conducting real-time multi-dimension inspection of multiple objects. The system provides a unique identity (“object personality”) to each object based on its attributes and spatial/motor manifold over time. The method and system of the present invention applies to objects that are seemingly identical, deformable, and/or randomly located.

In one exemplary embodiment, a system of the present invention is used in the context of a conveyor belt carrying multiple boxes and packages, many of which are seemingly identical to each other. The system comprises a plurality of real-time vision sensors and other sensors positioned above the conveyor belt to observe and record data in real-time of packages and boxes as they move on the belt. The vision sensors include, but are not limited to, 3D sensors, cameras, structured light sensors, time of flight sensors, laser sensors, infrared sensors, and the like. Other sensors include, but are not limited to, multi-package bar code readers and other forms of specialized sensors.

The system integrates and collects intrinsic attributes of the object along with extrinsic time/space/interactions of the object in real time. In addition to spatial recording (such as with Sensory Ego Sphere and related image mapping systems, as disclosed in U.S. Pat. Nos. 7,835,820 and 8,060,272, both of which are incorporated herein by specific reference in their entireties for all purposes), intrinsic symbol or logical data also may be attached to various nodes, resulting in the unique identification of the object by attaching a “personality” to it.

In one embodiment, the system combines the 3D shape of the object (which may be identical to thousands of others), with specific time, origination, destination, weight, movement through space, inherent damage, and other attributes and information. Based upon this identification, the system then automatically routes the package for appropriate handling.

In another embodiment, the system performs real-time unique pallet identification, tracking and routing by combining origination, destination, quality metrics, and a unique wood fingerprint of the specific pallet. This allows for tracking of each unique pallet to ensure that it is returned, and any in-transit damage may be accounted for.

In one embodiment, the system is installed on a personal computer or other computing device, and performs 3D calibration and integration (according to the methods described above). Spatial Vision software and a Neocortex Sensory Ego Sphere database may be incorporated.

### BRIEF DESCRIPTION OF THE DRAWINGS

FIG. 1 shows a view of a real-time box and package identification and routing system combining physical and logical data for each unique object.

FIG. 2 shows an example of a unique pallet fingerprint identifying this pallet as distinct from all other pallets.

FIG. 3 shows a side view of a bar code reader field of view.

FIG. 4 shows a view of an alternative box and package identification and routing system with structured light sensors.

### DETAILED DESCRIPTION OF EXEMPLARY EMBODIMENTS

Robots manipulate random objects in a cybernetic system after being supplied the position (X, Y, Z) and pose (Rx, Ry, Rz) from a vision guidance system. The vision guidance system typically identifies the object through surface matching, shape matching, or feature recognition. The robot then spatially tracks the object as part of a sensory/motor interaction. However, in a cause/effect closed cybernetic system, confusion arises when there are objects that are seemingly identical or indistinguishable, but require unique outcomes. An example of this is automated routing of boxes with the same physical shape but with different shipping origins and destinations.

The same is true with multi-dimensional inspection of an object. Software programs attempt to match enough of the object's surface, shape or features to cataloged objects or expected definitions to identify it. A good example is the observable geometry matching of facial recognition technologies. Or if the object is a machined part, then various metrics are conducted to ensure compliance with a standard. If the object is deformable, like a plastic bag, various blob analysis techniques may be used to identify objects. But these methods break down with identical twins or similar machined parts, such as, for example, two identical bags of potato chips. Embedding an RFID chip in the object attempts to overcome these problems, but often the RFID technology is too expensive or too fragile, and in some cases can modify the properties of the object.

In various embodiments, the present invention conducts real-time multi-dimension inspection of multiple objects, and provides a unique identity (“object personality”) to each object based on its attributes and spatial/motor manifold over time. The method and system of the present invention applies to objects that are seemingly identical, deformable, and/or randomly located.

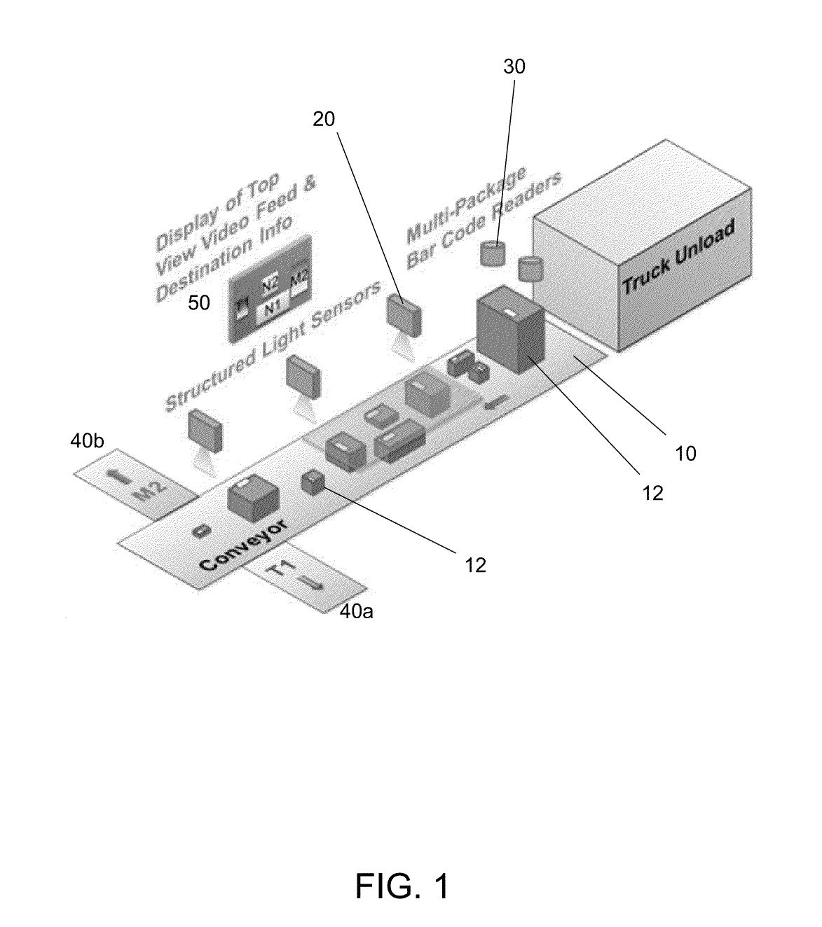

FIG. 1 shows an exemplary embodiment of a system of the present invention in the context of a conveyor belt 10 carrying multiple boxes and packages 12, many of which are seemingly identical to each other. The system comprises a plurality of real-time vision sensors 20 and other sensors 30 positioned above the conveyor belt to observe and record data in real-time of packages and boxes as they move on the belt. The vision sensors 20 include, but are not limited to, 3D sensors, cameras, structured light sensors, time of flight sensors, laser sensors, infrared sensors, and the like. Other sensors include, but are not limited to, multi-package bar code readers 30 and other forms of specialized sensors.

The system integrates and collects intrinsic attributes of the object along with extrinsic time/space/interactions of the object in real time. In addition to spatial recording (such as with Sensory Ego Sphere and related image mapping systems, as disclosed in U.S. Pat. Nos. 7,835,820 and 8,060,272, both of which are incorporated herein by specific reference in their entireties for all purposes), intrinsic symbol or logical data also may be attached to various nodes, resulting in the unique identification of the object by attaching a “personality” to it.

In one embodiment, the system combines the 3D shape of the object (which may be identical to thousands of others), with specific time, origination, destination, weight, movement through space, inherent damage, and other attributes and information. The system can associate destination with a specific box shape, monitor and track correlated information in real time, and display the destination and box image in real time 50. Based upon this identification, the system then automatically routes 40a, b the package for appropriate handling.

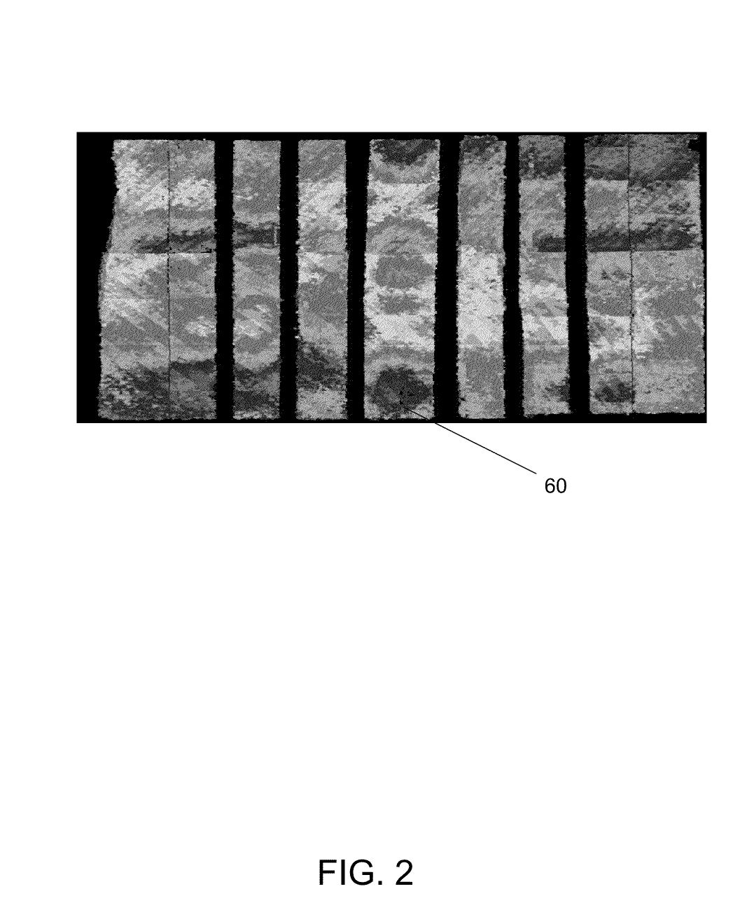

In another embodiment, the system performs real-time unique pallet identification, tracking and routing by combining origination, destination, quality metrics, and a unique wood fingerprint 60 of the specific pallet (as seen in FIG. 2). This allows for tracking of each unique pallet to ensure that it is returned, and any in-transit damage may be accounted for.

In one embodiment, the system is installed on a personal computer or other computing device, and performs 3D calibration and integration (according to the methods described above). Spatial Vision software and a Neocortex Sensory Ego Sphere database may be incorporated.

In one exemplary embodiment, the conveyor is 5 feet wide, and moves at 60 feet per minute. Package size varies, with the smallest package being 9″×6″×3″, and the largest being 20″×20″×20″. The system can handle up to 360 packages per minute.

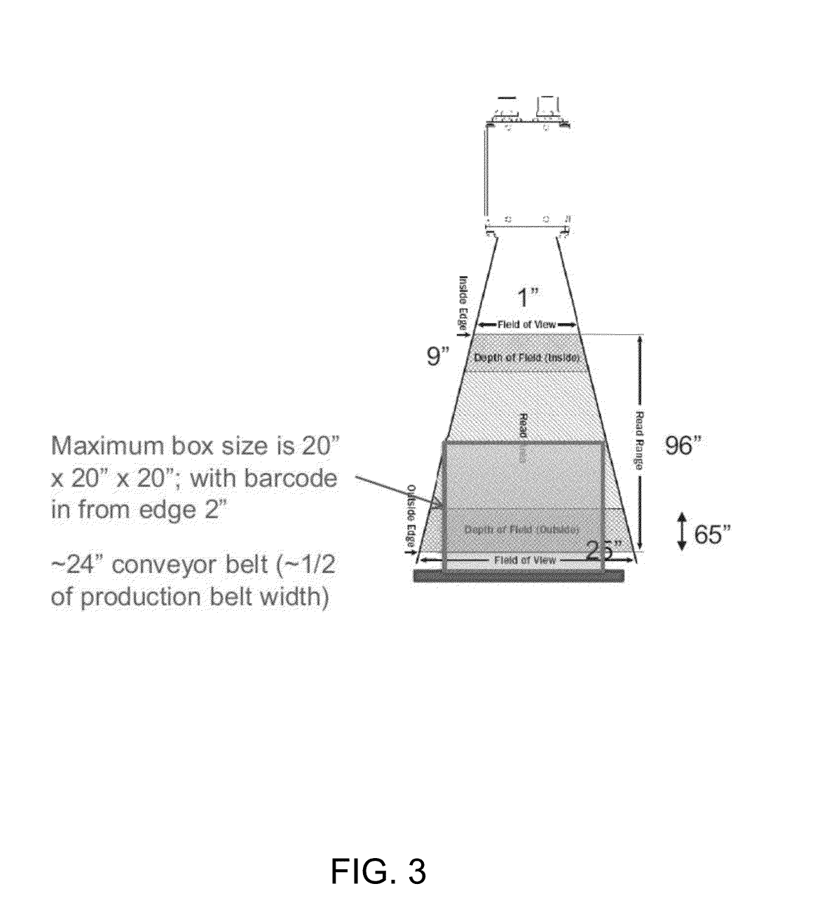

FIG. 3 shows an example of a bar code reader 30 used with the present system. The reader can decode up to 60 codes per minute, proceeding single file through the sensor. The maximum box sixe is 20″×20″×20″, with barcode at least 2 inches in from edge. The field of view cover 24 to 25 inches, so multiple readers are used to cover the width of a production conveyor belt as described above.

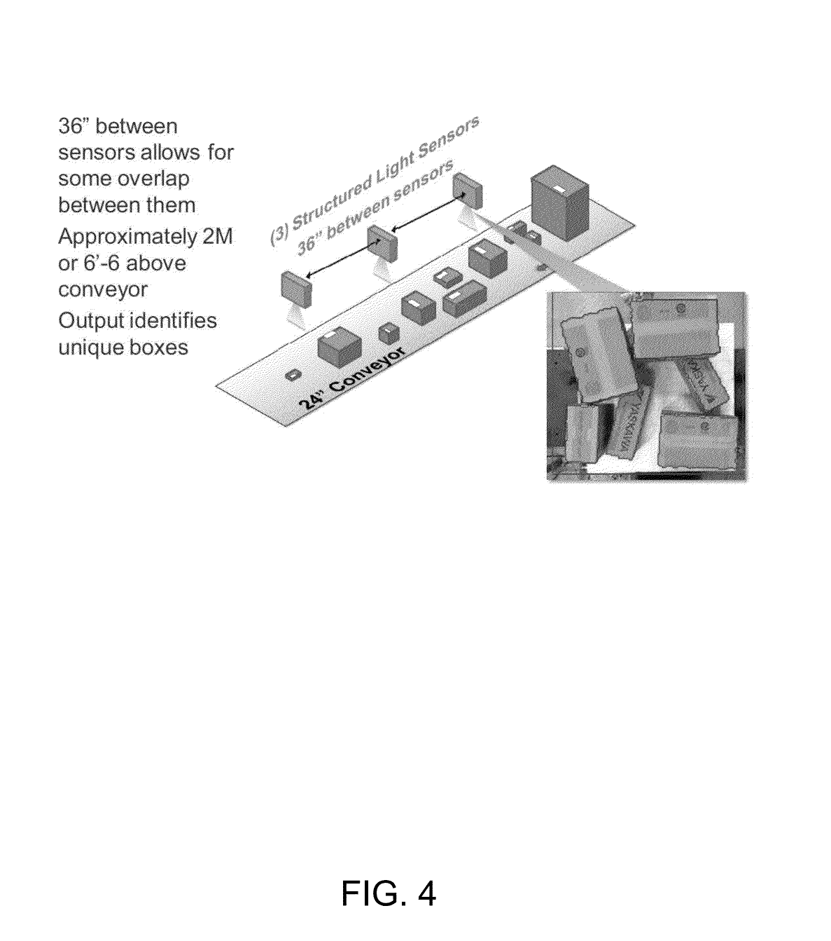

FIG. 4 shows another view of structured light sensor used with a 24 inch wide conveyor belt (although other belt sizes may be used). In this embodiment, the sensors are spaced 36 inches apart longitudinally along the belt, which allows for some overlap between the sensor. The sensors are placed approximately 6 to 7 feet above the conveyor.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism.

Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system, comprising:
a conveyor belt conveying a plurality of packages thereon, the plurality of packages each comprising a top side, said top side comprising at least package movement data and a bar code;
a plurality of vision sensors positioned around the conveyor belt to observe the plurality of packages in real time;
a plurality of bar code readers positioned above the conveyor belt to read the bar codes on said plurality of packages;
a computing device with a processor or microprocessor, wherein said processor or processor is programmed to receive observation data from said vision sensors and bar code data from said bar code readers to combine the three-dimensional shape of a particular package with specific package movement data for said particular package to automatically determine the destination for said particular package.

2. The system of claim 1, wherein said plurality of vision sensors comprise 3D sensors, cameras, structured light sensor, laser sensor, infrared sensors, or combinations thereof.

3. The system of claim 1, wherein said observation data comprises time, origination, destination, weight, and damage information.

4. The system of claim 1, further comprising a display screen, wherein said display screen displays a package image and destination for said package in real time.

5. The system of claim 1, wherein each package is automatically routed based on the determination of destination for each package.

6. The system of claim 1, further wherein said packages are loaded on pallets when conveyed, and the processor or processor is programmed to determine a unique fingerprint for each pallet.

7. The system of claim 6, wherein the processor or processor is programmed to track and route pallets based upon the fingerprint.
